(19) United States
(12) Patent Application Publication
(10) Pub. No.: US 2003/0085351 A1
(43) Pub. Date: May 8, 2003

(54) Optical fiber probe and scanning probe microscope provided with the same

(76) Inventors: Ken Nakajima, Saitama (JP); Masahiko Hara, Saitama (JP); Daisuke Fujita, Ibaraki (JP)

Correspondence Address: ROSENTHAL & OSHA L.L.P., 700 Louisiana, Suite 4550, Houston, TX, 77002, US

(21) Appl. No.: 10/179,429

(22) Filed: Jun. 25, 2002

(30) Foreign Application Priority Data
Nov. 8, 2001 (JP) 2001-343195

(51) Int. Cl. G12B 21/04; G12B 21/06

(52) U.S. Cl. 250/306

(57) ABSTRACT

The present invention provides an SNOM/STM incorporating a highly sensitive SNOM and which allows fluorescence observation. An aperture 33 of an aperture-type optical fiber probe 11 incorporated in an SNOM is coated with an ITO thin film 35 which serves as an electrode for STM.

### FIELD OF THE INVENTION

The present invention relates to a scanning probe microscope. More particularly, the present invention relates to a scanning probe microscope in which a near-field optical microscope and a scanning tunneling microscope are combined.

### BACKGROUND OF THE INVENTION

For measuring a structure or a property of a sample surface on an atomic or molecular level, scanning probe microscopes are known. Examples of the scanning probe microscopes include a scanning tunneling microscope (STM) which produces an image of a surface structure by utilizing tunneling current flowing between a probe and a sample, and an atomic force microscope (AFM) which produces an image by using atomic force acting between a probe and a sample. In addition, a magnetic force microscope (MFM) which allows observation of a magnetic distribution of, for example, a magnetic material, a scanning capacitance microscope (SCaM) which produces an image by detecting a change in electrostatic capacitance between a probe and a sample, and other microscopes have also been developed.

One type of such high-resolution scanning probe microscopes is a scanning near-field optical microscope (SNOM). Although various systems exist for SNOMs, a typical system is one that incorporates near-field light by placing, in proximity to a sample surface, a probe which is a fine optical fiber coated with a metal except for the tip. Whereas resolution of a conventional optical microscope is limited to about half the wavelength of the light due to a diffraction limit, an SNOM allows high resolution of about 50 nm. One of the factors that define the resolution of the SNOM is an aperture size of an aperture-type probe. In order to enhance the spatial resolution of the SNOM to an atomic/molecular level, the distance between the sample and the probe needs to be controlled on the order of several nm.

In order to enhance the resolution of the SNOM, the present inventors have previously developed an apparatus in which the SNOM and the STM are combined (Jpn. J. Appl. Phys., Vol. 38 (1999), pp. 3949-3953). This hybrid SNOM/STM uses a doubly metal-coated optical fiber probe. A doubly metal-coated optical fiber probe is a general SNOM probe (an optical fiber with a protruding conical core coated with platinum to a thickness of 100 to 150 nm except for the tip thereof) whose tip aperture is coated with a platinum ultra thin film to a thickness of 20 to 30 nm. The platinum ultra thin film with a thickness of 20-30 nm is semi-transparent to light and has electric conductivity. Since the aperture surface of the doubly metal-coated optical fiber probe for incorporating near-field light also has electric conductivity, STM measurement can be realized at the tip of the aperture of the probe. The developed hybrid SNOM/STM allows simultaneous SNOM/STM measurement and no displacement is caused between the SNOM and STM images obtained by the simultaneous measurement. By controlling the sample-probe distance at an STM constant current mode, the probe can be transferred while maintaining a constant distance from the sample surface. Therefore, the sample-probe distance can be controlled with high precision on the order of several nm.

Early SNOMs also control the distance with STM (Appl. Phys. Lett., 44, 651 (1984); J. Appl. Phys., 59, 3318 (1986)). In this case, however, displacement of about the size of the aperture is constantly caused between the obtained SNOM image and STM image due to the principle that the metal portion around the aperture serves as an operating point for electronic tunneling while the aperture itself serves as an incident window for photons.

The hybrid SNOM/STM using the above-described doubly metal-coated optical fiber probe can control the sample-probe distance with high precision on the order of several nm, thereby achieving high resolution of about 10 nm. The positions of an SNOM image and an STM image can be aligned to allow complete one-by-one correspondence between optical information and structural information.

An exemplary application of an SNOM includes fluorescence observation through excitation of fluorescent molecules. This applies to the case where a property of a optical-functional molecule is measured at a single molecule level. SNOMs are considered to become more important in the future as a tool for basic study in fields such as molecular electronics and the molecular photonics fields. On the other hand, the hybrid SNOM/STM using the doubly metal-coated optical fiber probe is not appropriate for fluorescence observation. This drawback is considered to be caused because the energy of the excited fluorescent molecules are not measured as fluorescence since the energy is transferred to a metal used for tunneling current detection which is placed within a distance of about 1 nm.

Furthermore, another drawback of the hybrid SNOM/STM using a conventional doubly metal-coated optical fiber probe is low sensitivity of the SNOM. This drawback is due to decreased light transmittance caused by the 20-30 nm platinum ultra thin film covering the aperture surface for incorporating near-field light in order to allow operation of STM. Since the platinum ultra thin film absorbs or reflects light, light detection sensitivity is 10% or less than that of an aperture-type probe.

In view of the above-described drawbacks, the present invention has an objective of providing an SNOM/STM which allows fluorescence observation. The present invention also has an objective of providing an SNOM/STM incorporating a highly sensitive SNOM.

### SUMMARY OF THE INVENTION

The present invention achieves the above-mentioned objectives by coating an aperture of an aperture-type optical fiber probe incorporated in an SNOM with an ITO (Indium Tin Oxide) thin film instead of a platinum ultra thin film.

Specifically, an optical fiber probe according to the present invention incorporated in a scanning probe microscope comprises: an optical fiber having a protruding conical head; a shielding film for preventing a ray from incoming to and outgoing from a region other than a tip region of the head; and an ITO thin film covering the tip region.

Since an ITO thin film absorbs less light and allows light transmittance of 80-90% in the visible light region, light detection sensitivity in the visible light region is enhanced by about one order. Resistivity of an ITO thin film is 1 to 10×10⁻⁶ Ωm which is higher than that of a metal, but sufficiently low as compared to the tunnel resistivity, and thus deterioration of the performance as an STM is insignificant as compared to a doubly metal-coated probe.

Furthermore, a scanning probe microscope according to the present invention comprises: the above-described optical fiber probe; a light source; a unit for guiding a ray emitted from the light source to outgo from the tip region of the optical fiber probe; a photodetector for detecting the ray incident to the tip region of the optical fiber probe; a first driver for driving the optical fiber probe along an optical axis of the ray outgoing from the optical fiber probe; a second driver for driving the optical fiber probe in two directions perpendicular to the optical axis of the outgoing ray; a scanning controller for outputting a scanning signal so that the second driver controls the optical fiber probe to perform two-dimensional scanning in directions perpendicular to the optical axis; a power source for applying a voltage between the optical fiber probe and a sample; a servo unit for servo controlling the first driver so that tunneling current flowing between the optical fiber probe and a sample is constant; and an image display unit into which output from the photodetector and the scanning signal from the scanning controller are input.

A scanning probe microscope according to the present invention can realize an SNOM with high resolution by combining an SNOM and an STM. Resolution that is five to ten times higher than an average resolution of a conventional aperture-type SNOM can be achieved.

The scanning probe microscope of the present invention allows fluorescence measurement which has been impossible with a conventional hybrid SNOM/STM using a doubly metal-coated optical fiber probe. Although reasons for this achievement yet cannot be fully explained at present, it possibly has something to do with an experimental fact that fluorescent molecules dispersed on an ITO film do not undergo non-radiative energy transfer (as actually confirmed under fluorescence microscopic observation) while fluorescent molecules dispersed on a metal may undergo non-radiative energy transfer (where when excited dye molecules approach the metal as close as several nanometers, the excitation energy transfers to the metal film to be converted into heat, thereby being relaxed without radiating light) (X. S. Xie, Acc. Chem. Res., vol. 29, 598-606 (1996)).

Moreover, the scanning probe microscope of the invention can maintain light detection sensitivity as high as that of an aperture-type optical fiber probe. Although light transmittance of an ITO thin film is slightly lower (80-90%) than that of an aperture-type probe (100%), probe-sample distance can be shortened to a great extent through operation as an STM. As a result, total efficiency can be maintained or enhanced as compared to conventional technique cases.

### BRIEF DESCRIPTION OF THE DRAWINGS

FIG. 1 is a schematic view showing a structure of an exemplary scanning probe microscope (hybrid SNOM/STM apparatus) according to the present invention;

FIG. 2 is a schematic view showing a tip of an optical fiber probe incorporated in the scanning probe microscope of the present invention;

FIG. 3 is an electron-microscopic image of the tip of the fabricated optical fiber probe;

FIGS. 4A to 4D are schematic views for comparing a tip of an optical fiber probe according to the invention and tips of conventional SNOM probes; and

FIGS. 5A and 5B are results of exemplary simultaneous SNOM/STM measurement using a scanning probe microscope of the invention.

### DETAILED DESCRIPTION OF THE INVENTION

Hereinafter, embodiments of the present invention will be described with reference to the drawings.

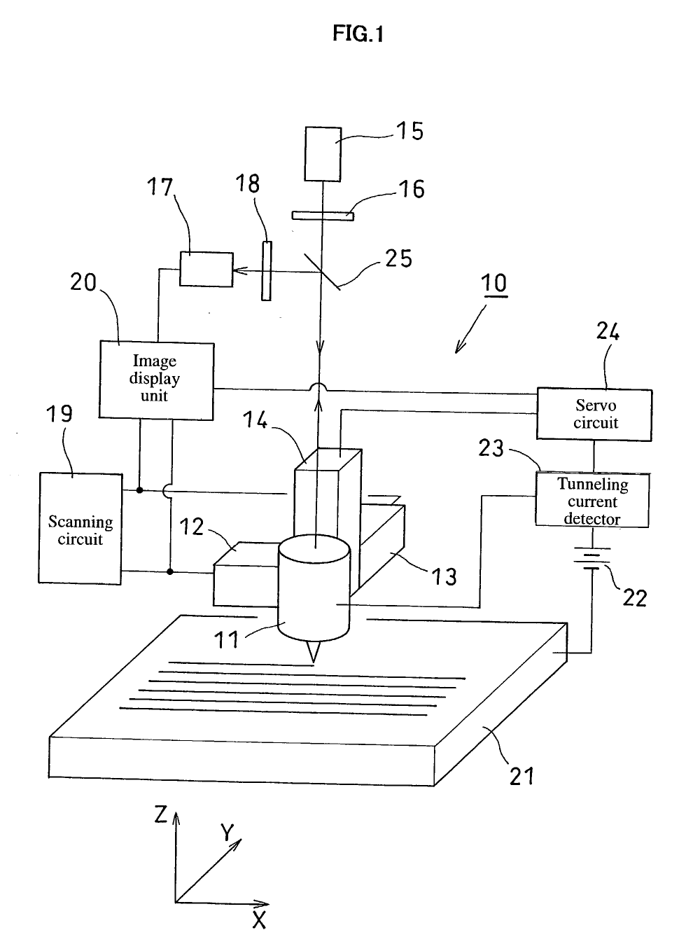

FIG. 1 is a schematic view showing an entire structure of an exemplary scanning probe microscope (hybrid SNOM/STM apparatus) according to the present invention.

The scanning probe microscope 10 is provided with: an optical fiber probe 11 whose details will be described later; X/Y-drivers 12 and 13 for driving the optical fiber probe 11 in X- and Y-directions, respectively; a Z-driver 14 for driving the optical fiber probe 11 in Z-direction; a light source 15 made of a laser or the like; a photodetector 17 such as a photomultiplier; optical filters 16 and 18; a scanning circuit 19 for outputting scanning signals to the X/Y-drivers 12 and 13 to transfer the optical fiber probe 11 for scanning in the X- and Y-directions; an image display unit 20 for displaying the signals detected by the photodetector 17, synchronous with the scanning signal output from the scanning circuit 19; a power source 22 for applying a voltage between the optical fiber probe 11 and a sample 21; a tunneling current detector 23 for detecting tunneling current flowing between the optical fiber probe 11 and the sample 21; and a servo circuit 24 for servo-controlling the Z-driver 14 such that the tunneling current detected by the tunneling current detector 23 is kept constant. The X/Y-drivers 12 and 13 and the Z-driver 14 are, for example, piezoelectric elements.

Light beam emitted from the light source 15 is incident to the optical fiber probe 11 via the optical filter 16 and a dichroic mirror 25 and directed from the tip of the optical fiber probe 11 to the sample 21. In the figure, Z-axis extends in a direction parallel to the optical axis of the ray outgoing from the optical fiber probe 11 toward the sample 21, while X- and Y-axes extend in crossing directions to each other on a plane perpendicular to the Z-axis. Light outgoing from the irradiated sample 21 is again incident to the optical fiber probe 11, reflected by the dichroic mirror 25, passes through the optical filter 18 and is incident to the photodetector 17. Output from the photodetector 17 and the scanning signal from the scanning circuit 19 are input to the image display unit 20 such as a CRT, whereby an SNOM image of the sample is displayed on the image display unit 20. By servo-controlling the Z-driver 14 so as to keep the tunneling current constant and inputting the output from the servo circuit 24 and the scanning signal from the scanning circuit 19 to the image display unit 20, an STM image of the sample is displayed on the image display unit 20.

On the other hand, a constant voltage from the power source 22 is applied between the optical fiber probe 11 and the sample 21. The tunneling current detector 23 detects tunneling current flowing between the sample 21 and the optical fiber probe 11. The servo circuit 24 controls the Z-driver 14 such that the detected tunneling current is constant, thereby controlling the distance between the sample surface and the optical fiber probe 11.

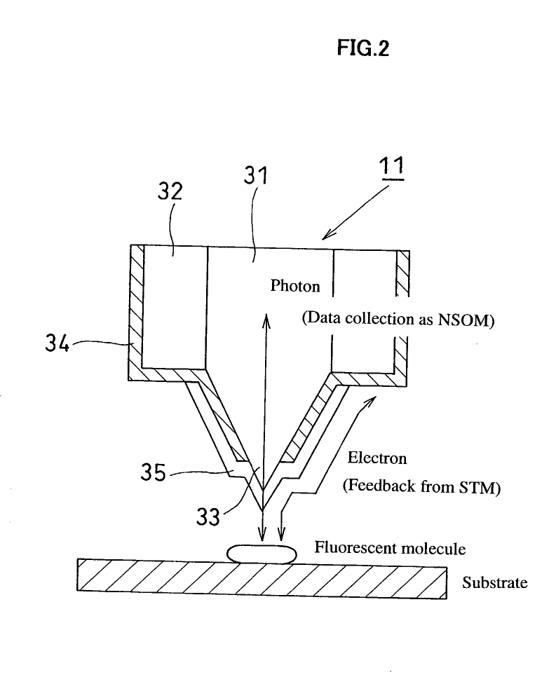

FIG. 2 is a schematic view showing an optical fiber probe (SNOM/STM probe) used in the scanning probe microscope of the present invention.

The optical fiber probe is obtained by tapering a tip of an optical fiber including a core 31 and a cladding 32. Then, a metal film 34 of platinum, gold or the like is formed as a shielding film with a thickness of 100-200 nm on the optical fiber except for the tapered tip of the core 31 to form an aperture 33 for the SNOM. The diameter of the aperture 33 is 50-200 nm. In addition, an ITO thin film 35 with a thickness of 10-100 nm is formed on the aperture 33. The ITO thin film 35 on the aperture 33 serves as an electrode for STM.

Hereinafter, a method for fabricating the above-mentioned optical fiber probe will be described.

Firstly, a 23 mol % doped-GeO₂ optical fiber (cladding diameter 125 μm, core diameter 8 μm) was etched in a solution of NH₄F (40 wt %): HF (50 wt %): H₂O (=2:1:1) for 2 hours. In this high-HF-concentration solution, the etching velocities of the cladding and the core were substantially equal (about 0.8 μm/min). Due to this etching, the cladding diameter was decreased to 30-40 nm. The length of the probe to be etched is directly related to mechanical stability of the probe. A probe length that allows good stability was about 0.5-1.0 mm. Next, the probe was etched in a solution of NH₄F (40 wt %): HF (50 wt %): H₂O (=10:1:1) for an hour. Unlike the first etching, the etching velocity of the cladding (0.3-0.4 μm) was faster than that of the core (0.1-0.2 μm). Accordingly, the core was exposed with its tip shaped into a corn. The conical tip had a root diameter of about 2 μm and a height from the root to the tip of about 5 μm. Cone angle is strongly dependent on the HF concentration and the doping amount of GeO₂ in the core. In the case of the optical fiber with the doping ratio of 23 mol %, a cone angle of 25° is obtained.

Then, gold-ion coating is performed on the obtained optical fiber with a tapered tip. A degree of vacuum in an ion coater is about 0.1 Torr. Thickness of the coating is 100-200 nm, which is determined by the degree of vacuum, sputtering time, and a distance between and positions of the fiber and the target. Subsequently, the gold-coated tapered optical fiber is immersed in an acrylic resin solution for a few seconds. Due to surface tension and viscosity of the acrylic resin and the tapered shape of the optical fiber tip, a length of several-tens to several-hundreds of nm from the tip is not covered with the acrylic resin, whereby the gold coating is exposed. Then, the optical fiber is immersed in an etching solution of KI:I₂:H₂O (=20:1:400) so that only gold on the tip is etched, thereby forming an aperture of about several-tens of nm.

Next, an ITO thin film is formed on the tip surface of this probe to a thickness of about 50 nm by magnetron sputtering technique. The resistivity of ITO was 5 to 10×10⁻⁶ Ωm. Light transmittance of ITO was 83-93% (wavelength 630 nm) at a thickness of 100 nm.

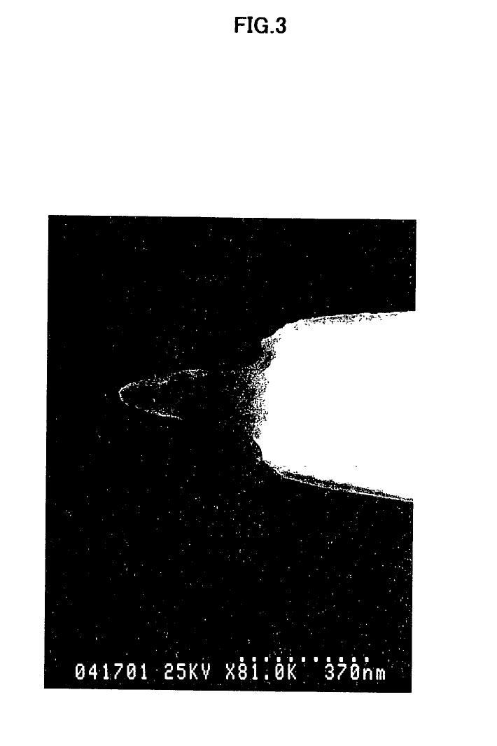

FIG. 3 is a microscopic image of the tip of the fabricated optical fiber probe. Since the aperture surface of this optical fiber probe is also covered with the ITO thin film and has electric conductivity, STM measurement can be performed at the tip of the aperture. Accordingly, there is no displacement between the two images obtained by simultaneous SNOM/STM measurement.

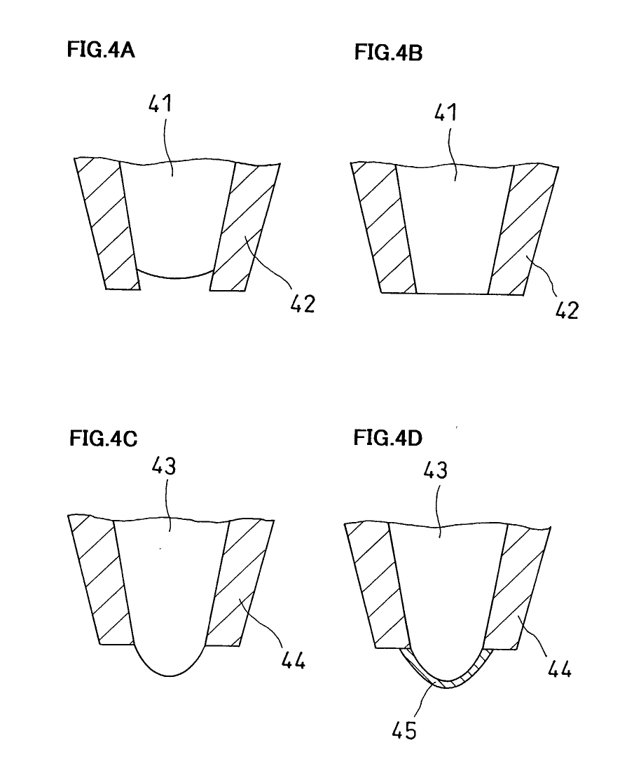

FIGS. 4A to 4D are schematic views for comparing a tip of the optical fiber probe according to the invention and tips of conventional SNOM probes. For SNOM probes used in other studies, a metal coating layer 42 covering an optical fiber 41 either protrudes from the tip of the optical fiber as shown in FIG. 4A or stays at the same level as the tip of the optical fiber as shown in FIG. 4B. In these cases, fluorescent molecules as the observation target will inevitably be close to the metal coating layer 42. On the other hand, for the optical fiber probe of the invention an optical fiber 43 as an aperture protrudes out from a metal coating layer 44 and forms a probe shape as shown in FIG. 4C. In this case, the metal coating layer 44 stays sufficiently distant from the sample placed underneath. When the protruding fiber is covered with a metal as in the case of conventional doubly metal-coated optical fiber probe, metal and fluorescent molecules will again be in proximity to each other. However, this problem can be avoided by covering the tip with an ITO thin film 45 as shown in FIG. 4D.

A scanning probe microscope (hybrid SNOM/STM apparatus) incorporating the optical fiber probe shown in FIG. 2 was used to carry out simultaneous SNOM/STM measurement. A sample was obtained by using a 50 nm-ITO-coated coverglass as a substrate, on which CdSe nanoparticles are spin coated. A density of the nanoparticles was about 100 times higher than that used in single particle observation with a general fluorescence microscope. The sample was prepared such that the nanoparticles were present densely in a region on the order of microns as observed with a fluorescence microscope. As an optical system, a diode-pumped solid state laser of 532 nm was coupled to an end surface of the optical fiber for performing local illumination using the tip of the optical fiber probe, detection using the optical fiber probe again (illumination & collection mode), and photon counting with the photomultiplier via a long pass filter of 580 nm (center wavelength of emission of CdSe nanoparticles was about 550-560 nm). Since the optical fiber is doped with GeO₂, the fiber itself emits red fluorescence under the excitation wavelength, which would be contained in a measurement value as an offset.

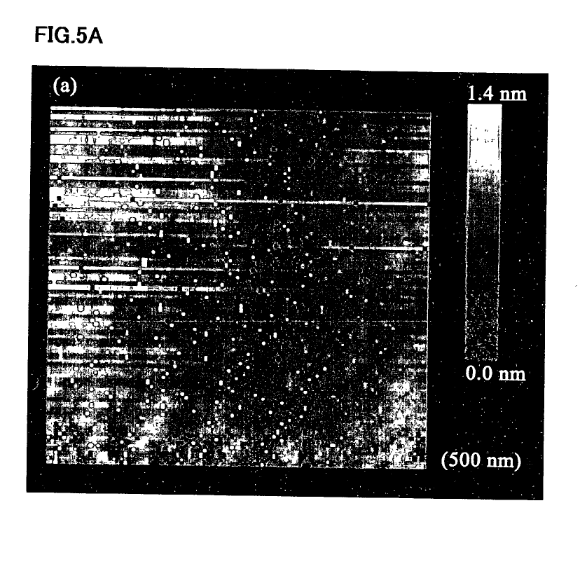

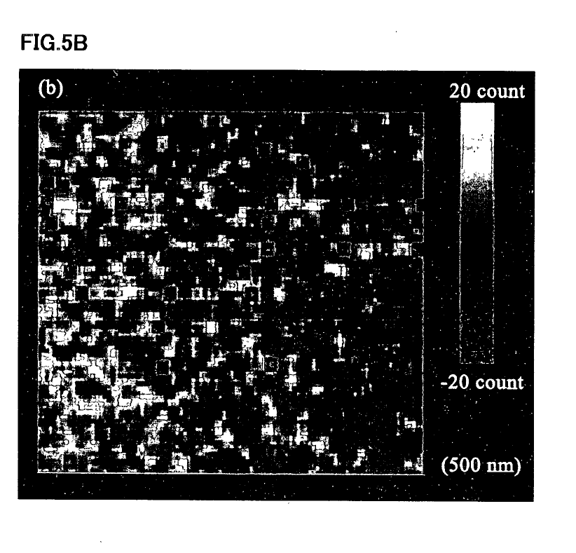

FIGS. 5A and 5B are results of exemplary simultaneous SNOM/STM measurement using the scanning probe microscope of the invention. Referring to an STM image shown in FIG. 5A (scanning range 380 nm, scanning velocity 0.13 Hz, 100×100 pixels, i.e., 38 msec/pixel), the roughness of the ITO thin film can be observed but individual CdSe nanoparticles (diameter of about 5 nm) are not resolved. An SNOM image shown in FIG. 5B is an image following elimination of the above-mentioned offset of about 400 count/pixel. Although individual bright peaks cannot be defined at present, they cannot even be obtained with a comparison measurement using an ITO thin film only. Therefore, some degree of fluorescence imaging is considered to have taken place successfully. As to the cross-section profiles of individual bright points appearing in the SNOM image, a full width at half maximum was about 20 nm which was very small as compared to the aperture size (50-200 nm).

Unlike a conventional doubly metal-coated optical fiber probe whose aperture is coated with a platinum ultrathin film, the optical fiber probe of the invention whose aperture is coated with ITO (with resistivity larger than that of a metal) causes almost no energy transfer of the excited fluorescent molecules, thereby allowing fluorescence observation. Moreover, resolution of an SNOM using an aperture-type optical fiber probe is defined by the aperture size. According to the present invention, STM feedback can be realized in principle and thus a probe-sample distance of 1 nm or less can be achieved. Accordingly, high resolution can be realized regardless of the aperture size.

In addition, optical detection can be highly sensitive (substantially equal to that of a conventional aperture-type optical fiber probe, and about 10 times higher than that of the doubly metal-coated probe) while maintaining resolution as high as that realized with a conventional doubly metal-coated probe. Therefore, weak light from, for example, a single quantum structure (including fluorescent molecules and nanoparticles) can rapidly be detected. The scanning probe microscope of the invention is, in principle, potentially applicable to optic- and electron-related phenomena. Specifically, the feature of STM can be utilized positively for, an application to electroluminescence via a tunnel electron injection, or an application to observation or control of change in electron states in various systems (organic molecules, semiconductor, etc.) via light excitation.

Thus, the present invention provides an SNOM/STM incorporating a highly sensitive SNOM and which allows fluorescence observation.

What is claimed is:

1. An optical fiber probe incorporated in a scanning probe microscope comprising:
an optical fiber having a protruding conical head;
a shielding film for preventing a ray from incoming to and outgoing from a region other than a tip region of the head; and
an ITO thin film covering the tip region.

2. A scanning probe microscope comprising:
the optical fiber probe of claim 1;
a light source;
a unit for guiding a ray emitted from the light source to outgo from the tip region of the optical fiber probe;
a photodetector for detecting the ray incident to the tip region of the optical fiber probe;
a first driver for driving the optical fiber probe along an optical axis of the ray outgoing from the optical fiber probe;
a second driver for driving the optical fiber probe in two directions perpendicular to the optical axis of the outgoing ray;
a scanning controller for outputting a scanning signal so that the second driver controls the optical fiber probe to perform two-dimensional scanning in directions perpendicular to the optical axis;
a power source for applying a voltage between the optical fiber probe and a sample;
a servo unit for servo controlling the first driver so that tunneling current flowing between the optical fiber probe and the same is constant; and
an image display unit into which output from the photodetector and the scanning signal from the scanning controller are input.
